(19) United States
(12) Patent Application Publication
(10) Pub. No.: US 2019/0087778 A1
(43) Pub. Date: Mar. 21, 2019

(54) Dynamic Load Matching Engine Methods and Systems

(71) Applicant: Konexial, Inc., Johnson City, TN (US)

(72) Inventor: Kenneth L. Evans, JR., Wichita, KS (US)

(21) Appl. No.: 16/147,676

(22) Filed: Sep. 29, 2018

Related U.S. Application Data
(63) Continuation of application No. PCT/US2017/064776, filed on Dec. 5, 2017.
(60) Provisional application No. 62/430,278, filed on Dec. 5, 2016.

(51) Int. Cl. G06Q 10/08; G06Q 30/02; G06Q 50/30

(52) U.S. Cl. CPC G06Q 10/08345; G06Q 10/08355; G06Q 50/30; G06Q 30/0283; G06Q 10/0833

(57) ABSTRACT

Systems and methods are disclosed for matching a shipper with at least one delivery agent for delivering goods from a first location to a second location. The method may be performed by one or more processors of a computing system. The method includes receiving shipment information from the shipper, receiving locational information and driver duty information relating to at least one delivery agent, determining a match of the shipper and the at least one delivery agent, at least based on the shipment information, the locational information, and the driver duty information, and communicating the match of the shipper and the at least one delivery agent.

This Application is a continuation of PCT Application No. PCT/US2017/064776 having a filing date of Dec. 5, 2017, which is hereby incorporated in its entirety. This application claims priority to U.S. Application No. 62/430,278, filed on Dec. 5, 2017, which is hereby incorporated by reference in its entirety.

All patents and publications described or discussed herein are hereby incorporated by reference in their entirety.

### STATEMENT REGARDING FEDERALLY SPONSORED RESEARCH OR DEVELOPMENT

This invention was made without government support. In this context, “government” refers to the government of the United States of America.

### BACKGROUND OF THE DISCLOSURE

Truck drivers and shipping companies typically profit the most from transporting trucks that are full, or mostly full, of cargo. It has been estimated that more than 20% of truck miles driven in the US are empty miles with no revenue-producing cargo in the truck. Not only are empty miles lost profit for truck owners and operators, but empty miles can be one of the biggest expenses to the owners and operators, as empty miles require truck maintenance and fuel.

Currently, in an effort to avoid empty miles, some carriers employ sales forces or work with third-party truck brokers to find freight for shipment. However, these solutions are often ad hoc, unreliable, and not scalable. Moreover, broker fees can be high, even up to 30% of the revenue for any loads of freight that the broker arranges. Further still, there is little to no transparency in broker and carrier transactions. These broker transactions are not in real-time, such that brokers, carriers, dispatchers, and/or drivers must coordinate their communications. The broker transactions are also not precise, as many times, drivers, carriers, and/or dispatchers make rough guesses as to truck empty capacity and location. Meanwhile, the shipping industry is facing increased regulation, such as the electronic logging device (ELD) rule. As such, a need exists for reducing empty miles in a way that is efficient, reliable, precise, scalable, can be done in real time, and ensures compliance with applicable laws and regulations, such as the electronic logging device (ELD) rule and Hours of Service Regulations from the Federal Motor Carrier Safety Administration (FMCSA), which are hereby incorporated by reference herein.

### BRIEF SUMMARY

The present disclosure provides systems and methods for dynamic load matching of shipments by shippers with transporters, such as delivery agents—e.g. carriers and/or drivers, which can also be described as a dynamic load and geographic-economic matching of freight transportation.

In a first aspect, a method of matching a shipper with at least one delivery agent for delivering goods from a first location to a second location is disposed. The method is performed by one or more processors of a computing system. The method includes receiving shipment information from the shipper, and receiving locational information and driver duty information relating to at least one delivery agent. The method includes determining a match of the shipper and the at least one delivery agent, at least based on the shipment information, the locational information, and the driver duty information, and communicate the match of the shipper and the at least one delivery agent to the shipper and the at least one delivery agent.

The method may include receiving freight capacity information regarding the at least one delivery agent. The freight capacity information may include asset classification, available capacity, or a combination thereof. The asset classification may include information regarding whether the goods require a flatbed trailer, a refrigerated trailer, a box truck, a container trailer, a tanker trailer, or a logging trailer for shipment. The available capacity may include information regarding a volume or a weight of available capacity that the at least one delivery agent can accept at a given time. The available capacity may be calculated by determining the total volume or weight capacity that of the delivery agent can accept when empty and subtracting the volume or weight being shipped by the at least one delivery agent at the given time.

The locational information may be received from an electronic logging device. The electronic logging device may be in communication with a vehicle of the at least one delivery agent. The shipment information may include information regarding geographical information of the first location and the second location, goods classification, goods volume, goods quantity, and shipping time information.

The method may include receiving driver duty information regarding a driver of the at least one delivery agent, wherein the determination of the match is additionally based on the driver duty information and the shipment information.

The method may include receiving a shipper offer price from the shipper, receiving a delivery agent offer price from the at least one delivery agent, and determining the match, based in additional part, on comparing the shipper offer price and the delivery offer price. The system may be configured to determine a non-match if the shipper offer price is less than the delivery agent offer price. If a non-match of the shipper offer price and the delivery agent offer price are determined, the method includes determining a generated offer price and transmitting the generated offer price to the shipper and the at least one delivery agent. The generated offer price may be the mean average of the shipper offer price and the delivery agent offer price. If the shipper and at least one delivery agent accept the generated offer price, the system may determine a match on price.

The one or more processors of the computing system may be configured to generate, on a display, an icon on a map indicating each of the at least one delivery agent. The icon may include an indicator of an available capacity of the driver duty information. The indicator may be a circle having a diameter positively correlating to the available capacity or the driver duty information.

In a second aspect, a method of matching a shipper with at least one delivery agent for delivering goods from a first location to a second location is disclosed. The method is performed by one or more processors of a computing system. The method includes receiving shipment information from the shipper, and receiving locational information, driver duty information, or freight capacity information relating to the at least one delivery agent. The method includes predicting locational information, driver duty information, or freight capacity information of the at least one delivery agent based on the shipment information and locational information, driver duty information, or freight capacity information. The method includes determining a match of the shipper and the at least one delivery agent, at least based on the shipment information from the shipper and the predicted location information, driver duty information, or freight capacity information of the at least one delivery agent communicating the match of the shipper and the at least one delivery agent to the shipper and the at least one delivery agent. The method includes communicating the match of the shipper and the at least one delivery agent to the shipper and the at least one delivery agent.

The one or more processors of the computing system may be configured to generate, on a display, a first icon having a first indicator on a map displaying the locational information, driver duty information, or freight capacity information. The one or more processors of the computing system may be configured to generate, on a display, a second icon having a second indicator on a map indicating the predicted locational information, driver duty information, or freight capacity information.

In a third aspect, the methods disclosed herein may be part of a system including a non-transitory computer readable medium storing instructions, that when executed by one or more processors of a computing system, cause a computing device to perform the methods or operations disclosed herein.

In a fourth aspect, the methods disclosed herein may be for reducing empty mileage in a vehicle of delivery agents, the vehicle configured to transport goods or freight.

The above presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF THE DRAWINGS

FIG. 1 illustrates an embodiment of the system and method of in accordance with an embodiment of the disclosure.

FIG. 2 illustrates a delivery agent in accordance with an embodiment of the disclosure.

FIG. 3 illustrates a flowchart of price matching in accordance with an embodiment of the disclosure.

FIG. 4 illustrates a map and icons in accordance with an embodiment of the disclosure.

FIG. 5 illustrates a map and icons in accordance with another embodiment of the disclosure.

FIG. 6 illustrates a map and icons in accordance with a yet another embodiment of the disclosure.

### DETAILED DESCRIPTION

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well-known functions or constructions may not be described in detail for brevity or clarity.

The terminology used herein is for the purpose of describing particular embodiments only and is not intended to be limiting. As used herein, the singular forms “a”, “an,” and “the” are intended to include the plural forms as well, unless the context clearly indicates otherwise.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “comprise” and “include” as used herein are inclusive and non-exclusive and should therefore be construed to mean “comprise/include but are not limited to.” Permissive and optional terms such as “may” or “some embodiments” as used herein are also inclusive and non-exclusive.

An “asset” refers to a commercial motor vehicle principally configured for transporting freight. Examples of assets include commercial cargo vans, pickup trucks, box trucks, semi-trailer trucks, timber log trucks, tank trunks, flatbed trucks, van trailers, car haulers, drop deck trailers, intermodal containers, refrigerated trailers, and livestock trucks.

“Carrier,” as used herein, includes an owner, an operator, a lessee and the driver of the asset. The server may generate an invoice to the shipper, and payment information may be received from the shipper by the server, from the carrier.

One or more embodiments described herein provide that methods, techniques, and actions performed by a computing device may be performed programmatically (e.g. performed through the use of code or computer-executable instructions). These instructions can be stored in one or more memory resources of the computing device. A programmatically performed step may or may not be automatic.

Embodiments described herein can be implemented using programmed modules, engines, or components. A programmatic module, engine, or component may include a program, sub-routine, a software component, a hardware component, or portions thereof, configured to perform one or more stated tasks or functions. A module or component can exist on a hardware component independently of other module or components, or can be a shared element or process of other module, programs, or machines.

Some embodiments described herein can generally require the use of computing devices, including processing and memory resources. For example, one or more embodiments described herein may be implemented, in whole or in part, on computer devices such as servers (including cloud computing), desktop computers, smartphones, laptop computers, network equipment, and tablets. Memory, processing, and network resources may all be used in connection with the establishment, use, or performance of any embodiment described herein, including with the performance of any method or with the implementation of any system.

One or more embodiments described herein may be implemented through the user of computer executable instructions, executable by one or more processors. These instructions may be carried on a computer-readable medium. Machines shown or described with figures below provide examples of processing resources and computer-readable mediums on which instructions for implementing embodiments of the invention can be carried out and/or executed. The numerous machines shown in embodiments of the invention include processors and various forms of memory for holding data and instructions. Examples of computer-readable mediums include permanent memory storage devices, such as hard drives on personal computers or servers. Computers and network enabled devices, such as smartphones, are examples of machines and devices that utilize processors, memory, and instructions stored on computer readable mediums. Additionally, embodiments may be implemented in the form of computer-programs, or a computer usable carrier medium capable of carrying such as program.

Embodiments described herein provide an interactive environment for enabling a user to request on-demand shipping services using a computing device. The shipping services may be a request from a user or customer to ship goods (i.e., a person desiring goods to be shipped), or a request from a user to receive goods to ship, such as a carrier, dispatcher, and/or driver (i.e., a person desiring to transport goods). In particular, some embodiments enable mobile computing devices, such as smart phones, ELDs, and geo-aware cellular telephony devices, to be used in connection with the services that enables the user to request the shipping services, using a simplified user interface schematic. Functionality, such as communicating the location of a vehicle for shipping goods, the type of vehicles available for shipping goods, the driver duty information (such as number of hours available to a driver during a day or week under an applicable law or rule), feedback ratings, and pricing can be aggregated and provided to the user in an efficient and user-friendly manner.

In one embodiment, a computing device can operate an application for requesting shipping services. The application can provide user interface features that provides a user of the application with information or enables the user to request a particular type of shipping service. For example, the user can be provided a mechanism for selecting services and service types, as well as displaying information that may affect the decision of the user in making such selections.

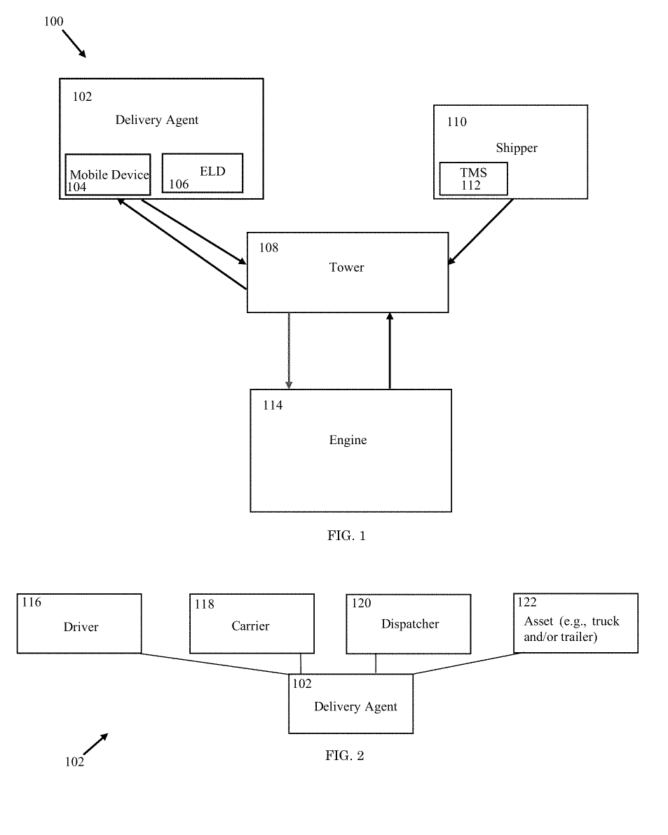

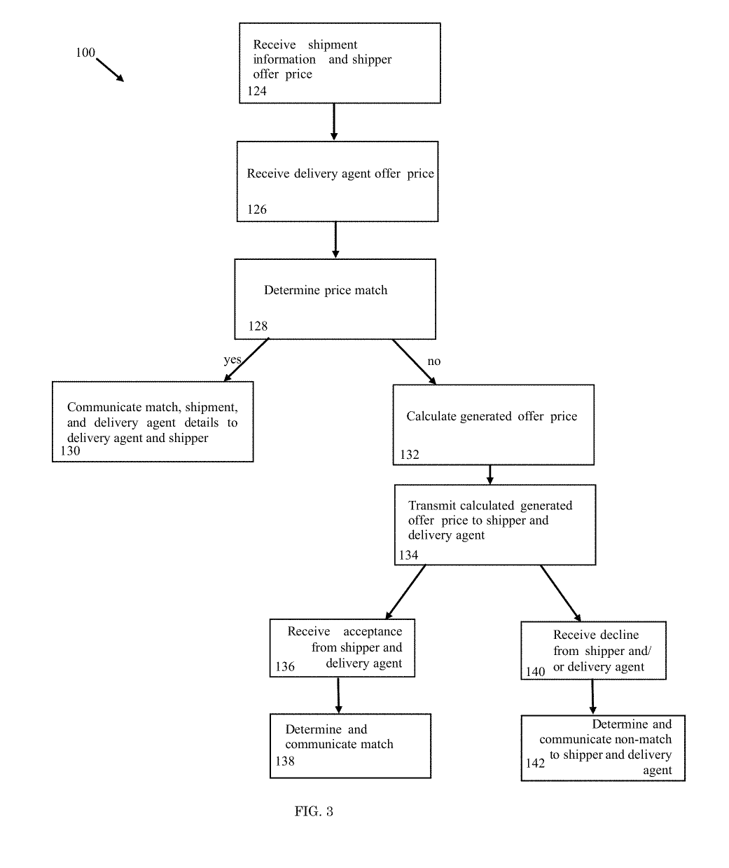

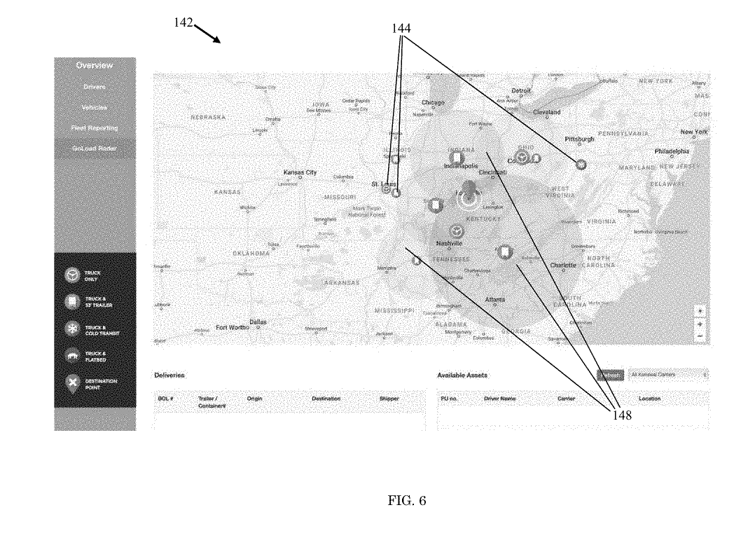

Referring now to FIGS. 1-6, according to an embodiment, a method of matching a shipper 110 with at least one delivery agent 102 for delivering goods from a first location to a second location is disposed. As used herein, a “shipper” is a party who desires goods to be shipped, or transported, from a first location to a second location remote to the first location. By way of example, a “shipper” may be a widget manufacturer who desires its widgets to be transported from its manufacturing facilities in Maine to a reseller in California. It will be appreciated that “shipper” can mean any party who desires goods to be shipped, including other carriers and brokers. The term “goods” may be used interchangeably with the word “freight,” and can include any tangible object, such as automobiles, logs, electronic equipment, liquids, textiles, animals, food, or chemicals. As used herein, “at least one delivery agent” refers to a party, or multiple parties, and/or the vehicle that they use, who transport goods from a first location to a second location. As shown in FIG. 2, “at least one delivery agent” may include a driver 116, a carrier 118, an asset 112, and/or a dispatcher 120, and combinations and pluralities thereof.

Thus, any communications with, or information about, the delivery agent 102 may be with any, all, or selectively the carrier 118, an asset 112, and/or a dispatcher 120. It will be appreciated that, in small shipping companies, the driver 116, carrier 118, and dispatcher 120 may be the same person, while large shipping companies may divide these roles among various different individuals and organizations. Typically, a dispatcher 120 is a party who makes economic decisions on behalf of the owner/lessee of the asset 122. Again, for smaller shipping companies, these can be the same person (e.g., owner/operator). An advantage of the instant disclosure is that the methods and systems may be deployed by, and interoperable between, small and large shipping operations.

The method includes receiving shipment information from the shipper 110. Shipment information may include information regarding geographical information of the first location, geographic information of the second location, goods classification (e.g., bulk liquid, automobiles, timber logs, packaged goods, and animals), goods volume, goods quantity, and shipping time information. Shipment information may include, or be accompanied by, shipper pricing information, discussed in more detail further below.

The method may include receiving locational information and driver duty information relating to the at least one delivery agent 102. The locational information of the at least one delivery agent 102 may include the geographic location information, the direction of travel, or the speed of the driver 116 or asset 122. The driver duty information may include, for example, hours-of-service rules imposed by law (i.e., duty cycle settings), such as the Federal Motor Carrier Safety Administration's Hours-of-Service Rules, and whether the delivery agent is currently accepting new delivery jobs (e.g., the delivery agent could enter a “non-active” status while on a vacation). By way of example, such rules or settings may include an 11 hour driving limit after 10 consecutive hours off duty, a 14 hour limit of on-duty following 10 consecutive hours of off duty, rest breaks of at least 30 minutes after 8 hours of driving, and 60/70 on duty limits in 7/8 consecutive days, which restart after taking 34 or more consecutive hours off duty. The driver duty information may include an “on” and “off” setting such that the driver 116 can indicate when he is seeking to transport goods and when he is off duty. The locational information and driver duty information may be configured to be received or collected, in real-time, automatically from an ELD 106 of the at least one delivery agent 102. The ELD 106 may be in communication with a vehicle of the at least one delivery agent 102. Advantageously, use of the ELD 106 enables information to be received and processed automatically, and the information is tamper-proof. The communicated information may be encrypted when communicated so as to be secure. The locational information and driver duty information may be configured to be received or collected from an API or a mobile device of a driver 116.

Further examples of driver duty information include may include number of duty hours remaining under laws or rules, such as federal or state laws and rules. For example, if a driver 116 has driven 2 hours per day and for no previous hours that week, under the US FMCSA-1 rule, the driver 116 has 9 duty hours remaining. The method and systems discussed herein may calculate the hours remaining for drivers 116 of the delivery agent 102. Examples of laws and rules which may be utilized include FMCSA1, FMCSA-2, Texas intrastate laws, Texas intrastate oil field laws, Washington intrastate laws, Florida intrastate laws, Illinois intrastate laws, California intrastate laws, Alabama intrastate laws, Canada Cycle 1 laws, and Canada Cycle 2 laws, all of which are hereby incorporated herein by reference. In some embodiments, the number of duty hours remaining changes in real time based on the delivery agent's 102 location, which is particularly advantageous for determining number of hours for intrastate laws as drivers 116 drive between states, or national laws when traveling between countries.

The method may include determining a match of the shipper 110 and the at least one delivery agent 102, at least based on the shipment information, the locational information, and/or the driver duty information. The method may weigh the values, and sub-values thereof, of the shipment information, the locational information, and/or the driver duty information by relative importance. The method may include communicating the match of the shipper 110 and the at least one delivery agent 102 to the shipper 110 and the at least one delivery agent 102 such that the shipper 110 and delivery agent 102 can complete a transaction.

The method may include receiving, and basing the matching on, driver preference data from the at least one delivery agent 102. Driver preference data may include, for example, waypoint locations through which the driver 116 desires to travel, desired locations for start point and end point (e.g., the first location and the second location), desire to be near a home terminal, preferred goods classification, and preferred delivery route. Further examples of driver preference data include the driver's preferences regarding classification of freight for shipment, quantity of freight for shipment, volume of freight for shipment, weight of freight for shipment, available volume space of the asset, available weight capacity of the asset, current asset route, or planned asset route.

The method may include receiving, and basing the matching on, insurance of the delivery agent 102 and its assets 122. The method may include receiving, and basing the matching on, public safety and fitness data publically available through the U.S. Department of Transportation's Federal Motor Carrier Safety Administration's Safety and Fitness Electronic Records (SAFER) system, which are hereby incorporated herein by reference. The method may automatically interface and communicate information with the SAFER system. Included in this information may be the Compliance, Safety, Accountability score, as further described below.

The method may include receiving feedback ratings from the shipper 110 for the at least one delivery agent 102. For example, the feedback rating may be selected from a rating of 1-5, which a five representing the highest rating. The feedback ratings may be averaged and caused to be displayed to other shippers 110, such that shippers 110 can manually select and filter delivery agents 102 using feedback as a criteria.

The method may include receiving, and basing the matching on, shipper criteria of the shipper 110. Shipper criteria may include, by way of example, Compliance, Safety, Accountability (CSA) score and, minimum insurance levels of the at least one delivery agent 102.

The method may include receiving filtering conditions, such as filtering by feedback rating, CSA score, minimum insurance levels, driver duty information, whether a power unit (i.e., motor vehicle having engine for hauling a trailer), shipment price (such as target rate per mile of the delivery agent 102 for transport), asset classification (the type of vehicle required by the goods for shipment, such as a flatbed trailer, a refrigerated trailer, a box truck, a container trailer, a tanker trailer, or a logging trailer for shipment). The filtering may be manual such as to constitute sorting, or automatic such that only delivery agents 102 meeting the filtering conditions are caused to be displayed to the shipper 110.

The method may use the data of the shipper 110 and the at least one delivery agent 102 to determine a match of the shipper 110 and the at least one delivery agent 102. The match may be determined on any of the data disclosed herein, including at least based on the shipment information, the locational information, and the driver duty information. The match, or lack thereof, may be communicated to the shipper 110 and the at least one delivery agent 102. The match may be a match of degree (e.g., a 100% match, a 95% match, a 90% match) and ordered by the degree of match. The degrees of match may be communicated and caused to be displayed to the shipper 110 and the delivery agent 102 such that the parties can select a preferred match.

The method may include receiving freight capacity information regarding the at least one delivery agent 102. The freight capacity information may include asset classification, available capacity, or a combination thereof. As used herein, “asset classification” includes information regarding whether the goods for shipment require a flatbed trailer, a regenerated trailer, a box truck, a container trailer, a tanker trailer, a logging trailer, and automotive trailer, or a power unit, to ship the goods. The terms “available capacity” or “freight capacity” may include information regarding a volume or a weight of available capacity that the at least one delivery agent 102 can accept at a given time. The available capacity may be calculated by determining the total volume or weight capacity that the delivery agent 102 can accept when empty and subtracting the volume or weight being shipped by the at least one delivery agent 102 at a given time. By way of example, if a trailer of a delivery agent 102 has a total capacity (i.e., empty capacity) of 40,000 liters, and is hauling 10,000 liters of goods at a given time, the trailer would have an available capacity of 30,000 liters.

Referring to FIG. 3, the method may include receiving a shipper offer price 124 from the shipper 110. By way of example, the shipper offer price, and any data referred to herein, may be entered by the shipper 110 via a graphical user interface (GUI) generated by the computing system. Also, the methods may cause any data referred to herein to be displayed to the delivery agent 102 and/or the shipper 110 on the GUI. As used herein, “shipper offer price” means a price that a shipper 110 is offering to pay to ship goods from a first location to a second location. The method may include receiving a delivery agent offer price 126 from the delivery agent 102. As used herein, “delivery agent offer price” means a price for which the at least one delivery agent is offering to ship goods from a first location to a second location. The shipper offer price and the delivery agent offer price may be a flat rate, an hourly rate, or a per mile driven rate (direct or actual route). The shipper offer price may be hidden or secured from the delivery agent 102 and the delivery agent offer price may be hidden or secured from the shipper 110 until both the shipper offer price and the delivery agent offer price are received.

The method may include determining 128 whether the shipper offer price and the delivery agent offer price match (i.e., an economic match). The match may be determined 130, and communicated to the parties along with shipment and delivery agent details, if, for example, the prices are the same, or if the shipper offer price is greater than the delivery agent offer price. In one embodiment, if the shipper offer price is greater than the delivery agent offer price, a match is determined and a mean average price is calculated from the prices and communicated to the shipper 110 and the delivery agent 102. The method may include determining a non-match if the shipper offer price is less than the delivery agent offer price. As used herein, a “non-match” means that the shipper offer price is less than the delivery agent offer price. In some embodiments, the method causes an indicator to be displayed showing that a non-match was generated to the shipper 110 and the delivery agent 102. In other embodiments, the method causes matches to be displayed and does not include non-matches so that the parties can view matches but not non-matches.

If the method determines a non-match of prices from the shipper 110 and the delivery agent 102, the method may include determining (e.g., calculating) 132 a generated offer price and transmitting 134 the generated offer price to the shipper 110 and the at least one delivery agent 102. The generated offer price is utilized as a “second chance” for the parties to match. By way of example, the generated offer price may be the calculated mean average of the shipper offer price and the delivery agent offer price. The generated offer price may be, for example, the average matched shipping price of a plurality of matched shippers 110 and respective delivery agents 102. A match may be determined if the shipper 110 and the delivery agent 102 each accept the generated offer price and the acceptance is received 136. The match may then be determined and communicated to the parties. In some embodiments, when a match is determined for shipment information and delivery agent information, such as duty status, but not price (e.g., a non-economic match), the method may include notifying the shipper 110 and the delivery agent 102 at what price a match would have been made, and enabling the party to select an indicator (such as a raise or lower button) to communicate a raised or lowered price offer to create a full match. If a decline is received from the shipper 110 and/or the delivery agent 102, a non-match is determined and communicated 142 to the shipper 110 and the delivery agent 102.

In an embodiment, the method includes receiving target and maximum shipper offer price information for a particular shipment from the shipper. The method may include receiving shipper criteria for minimum CSA score, insurance requirements, and feedback rating. The method may include filtering, or determining non-matches, for delivery agents 102 that do not meet the shipper criteria.

In an embodiment, when a match is determined for all parameters, the match is automatically accepted and all relevant shipment information and delivery agent information is transmitted to one another. In other embodiments, when a match is determined for all parameters, the system causes an indicator for a match to be displayed to the delivery agent 102 and the shipper 110, both of whom have to select to accept the match. The shipper 110 and delivery agent 102 may have to accept the match within a period of time (e.g., less than 3 days, less than 2 days, less than 24 hours, less than 12 hours, less than 10 hours, less than 8 hours, less than 6 hours, less than 4 hours, less than 2 hours, less than 1 hour, less than 30 minutes) or the method may cancel the match, cancelling the parties' ability to accept the match and receive relevant shipment and delivery agent information.

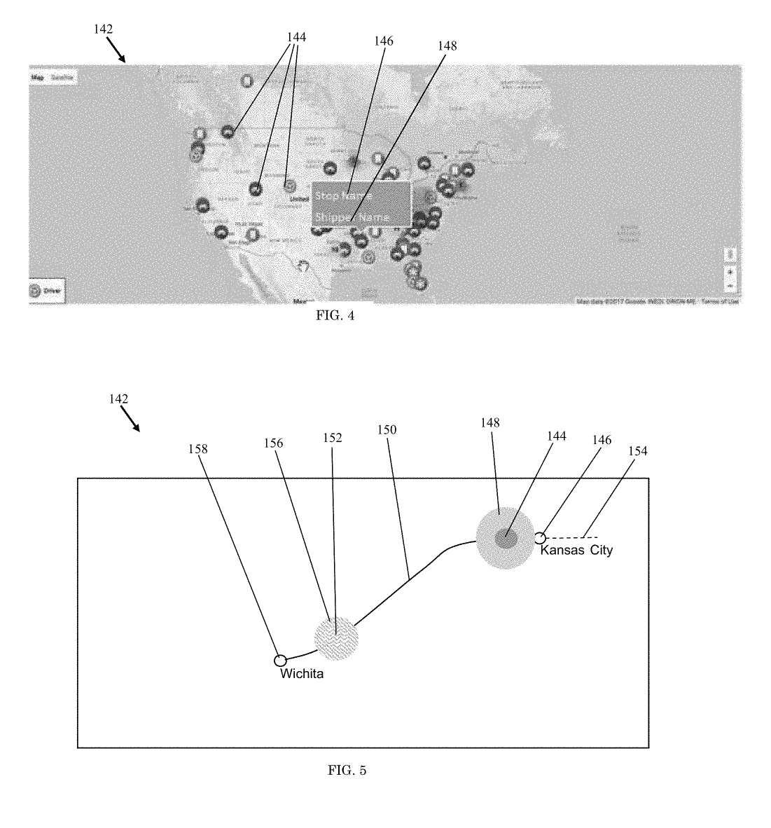

Referring to FIGS. 4-6, the method may include generating, on a display, an icon 144 on a map 142 indicating the delivery agent 102. The map may have zoom and pan functionality, and display the plurality of icons 144 indicating a plurality of respective delivery agents 102. The icons 144 may be real-time representations of the delivery agents 102, displaying, for example, the locational (e.g., latitude and longitude) information (or any other information) of the delivery agent 102. Stop names 146 and shipper names 148 may also be included for each icon 144. The icon 144 may be caused to be displayed by on, for example, a computing device 104 (e.g., a mobile device such as a smartphone) of the delivery agent 102 or the shipper 110. In some embodiments, different icons 144 are used for different asset classifications (e.g., a first icon type for a flatbed trailer and a second icon type for a logging trailer). The icon 144 may include an indicator 148 of an available capacity of the delivery agent 102 or the driver duty information. The indicator 148 may be, for example, a shape, such as a circle (or bubble), that has a size that positively correlates to the available capacity or the driver duty information. By way of example, and as shown in FIG. 5, the shape may be a circle that has a large diameter when the driver 116 has many available drive hours remaining on a cycle, such as a week or day, or a circle that has a small diameter when the driver 116 has few hours remaining on a cycle. The size of the indicator 148 may be based on driver duty information, available combination, an average, or a weighted average thereof. The size of the shape may update in real time based on the information received (e.g., the diameter of the circle becomes respectively smaller as the driver 116 drives and uses available drive time under applicable laws and rules). The radius of the circle may indicate, on the map, the distance that can likely be traveled by the delivery agent 102 in the driver's 116 remaining hours of service. The size of the shape, such as the diameter of the circle, may be calculated by using, for example, duty hours available multiplied by the driver's 116 average speed multiplied by a constant (e.g., 0.1-10, 0.5-5, etc.). In another embodiment, the driver's 116 average speed may be assumed to be a constant (e.g., 30 mph, 40 mph, 50 mph, 55 mph, 60 mph, 65 mph, 70 mph, or any subrange thereof).

In another embodiment, the method may include generating and causing to be displayed a travel history 154 of the delivery agent 102 (e.g., a bread crumb toggle) showing the past travel history of the delivery agent 102. The travel history 154 may show travel history for multiple shipments or for a single shipment. The method may include causing to be displayed a series of shapes, such as dots, emanating from the icon 144 on a map to show the travel history 154 of the delivery agent 102. The map 154 may be filtered such that only assets 112 owned by, or controlled by, a delivery agent are caused to be displayed. This is advantageous as, for example, a carrier may view all assets 112 as icons 144 on a single map 154.

In an embodiment, the method may include interfacing with Transportation Management Systems (TMS) 112 to receive offers to ship goods (i.e., shipment tender). The interfacing may be interfacing through an application programming interface (API). The ability to interface with shippers' 110 TMS 112 systems is particularly advantageous, as it allows automation with various forms of TMS 112 without further user input

In an embodiment, the method includes calculating detention and demurrage, calculating fuel used and price (using, for example, PC*MILER® and priced according to Oil Price Information Service (OPIS)® real time retail fuel prices). The method may include receiving payment and payment information from the shipper 110, and transmitting payment and payment information to the delivery agent 102. This payment information may be transparent to both parties, such that both parties are able to view the payment information sent and received, as well as any deductions made (for example, a clearinghouse fee for the matching methods and systems described herein).

In some embodiments, fuel rates may be received from and transmitted to the delivery agent 102. The fuel rates may be received, from, for example, databases such as OPTS®, GasBuddy® or website databases of fuel prices from service center operators, such as those of PILOT® and FLYING J®. The methods may include determining optimal fuel stops for the delivery agent 102, including processing data such as driver duty information, the first location, the second location, traffic conditions, weather, and fuel prices. The determined optimal fuel stops may be transmitted to the delivery agent 102 and caused to be displayed on a computing device of the agent, such as a smartphone.

In another aspect, a method of matching a shipper 110 with at least one delivery agent 102 for delivering goods via a route 150 from a first location 154 to a second location 156 is disclosed. The method includes receiving shipment information from the shipper 110, and receiving locational information, driver duty information, or freight capacity information relating to the at least one delivery agent 102. This data, like any data discussed herein, may be received and processed in real time. The method includes a prediction feature that includes predicting locational information, driver duty information, or freight capacity information of the at least one delivery agent 102, based on the shipment information and locational information, driver duty information, or freight capacity information. By way of example, the method may use input data such as direction of travel, current speed, traffic conditions, weather, shipment information, and driver duty information to predict future locational information, driver duty information, or freight capacity information. Based on the predicted location information, driver duty information, or freight capacity information, the method can include determining a match of the shipper 110 and the delivery agent 102. The prediction feature is a technical solution that solves an unmet technical problem—that is, predicting future capacity and duty status of delivery agents 102, and using the prediction feature, matching future shipping capacity with future shipping need. Indeed, the predicting step increases precision of predicting driver duty information and available capacity of a delivery agent 102, including assets 122. The method may include generating, on a display, a first icon (e.g., real-time icon) having a first indicator on a map displaying the locational information, driver duty information, or freight capacity information, as discussed above.

The method may include generating, on a display, a second icon 152 (e.g., predicted icon) having a second indicator 154 on the map 142 indicating the predicted locational information, driver duty information, or freight capacity information. In an embodiment, and as shown in FIG. 5, the method includes causing the first icon 144, the predicted icon 152, the first indicator 144, and the predicated indicator 154 to be displayed on the map 142 such that the real time data of the delivery agent 102 (e.g., truck) and the predicted data are displayed and tracked on the same map 142.

According to some embodiments, a filtering feature can selectively choose and display matches to user input. By way of example, if a user would like to ship a particular type of good that requires refrigeration, the user can select a “refrigeration” selection that will limit displayed choices to those with refrigeration. As will be described further herein, the filtering feature can select for and display many different kinds of information. The filtering feature may also be automatic in that only matched delivery agents 102 are displayed to shippers 110.

Another operation performed by the executed instructions of the medium stored on the first client include transmitting locational information, driver duty information data and driver preference data.

The methods disclosed herein may be part of a system including a non-transitory computer readable medium storing instructions, that when executed by one or more processors of a computing system, cause a computing device to perform the methods or operations disclosed herein.

Referring to FIG. 1, in one embodiment of the system, the system separates communication with delivery agents 102 and shippers 110 from the portion of the system that processes and determines information, including matching. In this embodiment, a tower 108 can send and receive information about the delivery agents 102 and shipment information. The tower 108 may also communicate with TMS 112 through, for example, API. The tower 108 communicates all information, or any subcombination of the information mentioned herein, with an engine 114. The engine 114 may perform the calculations, matching, and determinations mentioned herein based on the received information, and communicate the resulting processed information to the tower 108 for communication to shippers 110 and delivery agents 102. In some embodiments, the tower 108 and engine 114 are on the same server, however, they may be contained on different servers, including different virtual machines operating on the same server. Thus, the tower 108 may have perform the functions or steps that interface with third parties, and the engine 114 may perform the calculations.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and are capable of changes or modifications within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. § 1.77 or otherwise to provide organizational queues. These headings shall not limit or characterize the invention(s) set forth herein.

What is claimed is:

1. A method of matching a shipper with at least one delivery agent for delivering goods from a first location to a second location, the method being performed by one or more processors of a computing system and comprising:
receiving shipment information from the shipper;
receiving locational information and driver duty information relating to at least one delivery agent;
determining a match of the shipper and the at least one delivery agent, at least based on the shipment information, the locational information, and the driver duty information; and
communicating the match of the shipper and the at least one delivery agent to the shipper and the at least one delivery agent.

2. The method of claim 1, further comprising receiving freight capacity information regarding the at least one delivery agent.

3. The method of claim 2, wherein the freight capacity information includes asset classification, available capacity, or a combination thereof.

4. The method of claim 3, wherein the asset classification includes information regarding whether the goods require a flatbed trailer, a refrigerated trailer, a box truck, a container trailer, a tanker trailer, or a logging trailer for shipment.

5. The method of claim 3, wherein the available capacity includes information regarding a volume or a weight of available capacity that the at least one delivery agent can accept at a given time.

6. The method of claim 5, wherein the available capacity is calculated by determining the total volume or weight capacity that the delivery agent can accept when empty and subtracting the volume or weight being shipped by the at least one delivery agent at the given time.

7. The method of claim 1, wherein the locational information is received from an electronic logging device.

8. The method of claim 1, wherein the electronic logging device is in communication with a vehicle of the at least one delivery agent.

9. The method of claim 1, wherein the shipment information comprises information regarding geographical information of the first location and the second location, goods classification, goods volume, goods quantity, and shipping time information.

10. The method of claim 1, further comprising:
receiving driver duty information regarding a driver of the at least one delivery agent, wherein the determination of the match is additionally based on the driver duty information and the shipment information.

11. The method of claim 1, further comprising:
receiving a shipper offer price from the shipper;
receiving a delivery agent offer price from the at least one delivery agent; and
determining the match, based in additional part, on comparing the shipper offer price and the delivery offer price.

12. The method of claim 11, further comprising determining a non-match if the shipper offer price is less than the delivery agent offer price.

13. The method of claim 12, wherein if a non-match of the shipper offer price and the delivery agent offer price are determined, the method comprises determining a generated offer price and transmit the generated offer price to the shipper and the at least one delivery agent.

14. The method of claim 13, wherein the generated offer price is the mean average of the shipper offer price and the delivery agent offer price.

15. The method of claim 13, wherein if the shipper and at least one delivery agent accept the generated offer price, the system determines a match on price.

16. The method of claim 1, wherein the one or more processors of the computing system are configured to generate, on a display, an icon on a map indicating each of the at least one delivery agent.

17. The method of claim 16, wherein the icon corresponds to an asset classification.

18. The method of claim 16, wherein the icon includes an indicator of an available capacity or the driver duty information.

19. The method of claim 18, wherein the indicator is a circle having a diameter positively correlating to the available capacity or the driver duty information.

20. A method of matching a shipper with at least one delivery agent for delivering goods from a first location to a second location, the method being performed by one or more processors of a computing system and comprising:
receiving shipment information from the shipper;
receiving locational information, driver duty status, or freight capacity information relating to the at least one delivery agent;
predicting locational information, driver duty status, or freight capacity information of the at least one delivery agent, based on the shipment information and locational information, driver duty status, or freight capacity, information;
determining a match of the shipper and the at least one delivery agent, at least based on the shipment information from the shipper and the predicted location information, driver duty status, or freight capacity information of the at least one delivery agent; and
communicating the match of the shipper and the at least one delivery agent to the shipper and the least one delivery agent.

21. The method of claim 20, wherein the one or more processors of the computing system are configured to generate, on a display, a first icon having a first indicator on a map displaying the locational information, driver duty status, or freight capacity information.

22. The method of claim 20, wherein the one or more processors of the computing system are configured to generate, on a display, a second icon having a second indicator on a map indicating the predicted locational information, driver duty status, or freight capacity information.
